(19) United States
(12) Patent Application Publication
(10) Pub. No.: US 2002/0125247 A1
(43) Pub. Date: Sep. 12, 2002

(54) Electrical wiring box

(76) Inventor: Thomas R. Kruer, Edgewood, KY (US)

Correspondence Address: Jim Blackwood, 328 Stevenson Rd., Erlanger, KY, 41018, US

(21) Appl. No.: 10/090,947

(22) Filed: Mar. 5, 2002

Related U.S. Application Data
(60) Provisional application No. 60/273,510, filed on Mar. 6, 2001.

(51) Int. Cl. H02G 3/08

(52) U.S. Cl. 220/3.5; 220/3.8

(57) ABSTRACT

An electrical wiring box with outer dimensions specifically sized and shaped to match a standard architectural component is disclosed. The disclosed electrical wiring box is of a minimum size corresponding to industrial standards and configured to accept standard electrical wires and fittings. The outer dimensions of the disclosed electrical wiring box are selectively larger than the standard box. The invention discloses an electrical wiring box which is the size of a standard fired clay building brick, or fraction thereof, thus simplifying installation in a wall of brick and mortar construction. The invention further discloses a cover which simulates a brick surface thus providing for improved appearance when installed in a brick wall. The electrical wiring box disclosed in this invention can take a number of different configurations and be used in different orientations to provide simplified installation and improved aesthetics.

### FIELD OF INVENTION

This invention relates to electrical wiring boxes used in construction for installation and terminating of electrical conductors. More specifically, this invention relates to electrical wiring boxes mounted within brick and mortar walls. The disclosed electrical wiring boxes may be installed in new, replacement, and remodeling applications.

### BACKGROUND OF INVENTION

Electrical wiring boxes are typically used to terminate one or more electrical conductors and provide a secure mounting for electrical receptacles, light switches, and fixtures. They are produced in numerous standard sizes and shapes and of various materials consistent with the requirements of the application. The shapes, dimensional sizes, and materials for approved electrical wiring boxes are specified by section 314 of the 2002 Edition of the National Electric Code.

Electrical wiring boxes are typically installed in new and remodeling construction wherever an electrical receptacle, light switch, or fixture is desired. They are installed within interior and exterior walls. Many of these walls are constructed of vertical studs and sheeting with some having a veneer of laid up mortar and brick. However, standard electrical wiring boxes are smaller than a standard fired clay building brick. Therefore, when conventional electrical wiring boxes are incorporated into a brick wall, one or more bricks must be cut in order to maintain the consistent overlapped lay up pattern. When the electrical wiring box is smaller than the brick it replaces, mortar needs to be added to fill the space around the box. In addition, some boxes are larger than a standard building brick thus requiring that two courses of brick be modified to accept the box Alternatively, the brick may be laid up without incorporating the electrical wiring box and then the brick must be drilled for passage of the wire, or wires. The electrical wiring box is then fixedly mounted onto the surface of the brick so as to cover the hole made for the wire or wires. This alternate style of installation is difficult and time consuming as the brick must be drilled for the wire and for mounting screws. It also creates a path for moisture or water to enter the internal building structure.

U.S. Pat. No. 4,223,377 and 5,833,351 disclose structural building units “shaped and sized similar to a conventional house brick and may be incorporated into walls to provide illumination or security devices.” However, these devices are not designed to accept electrical fittings, i.e., conductors, receptacles, and switches, thereby they do not function as an electrical wiring box as the current invention. In addition, these devices make no provision for mounting exterior electrical fixtures and lack a decorative cover to blend with the surrounding wall.

When incorporated into a brick wall, a conventional electrical wiring box and associated cover appears out of place as it breaks the consistent brick and mortar pattern. When mounted on the surface of the wall, the conventional electrical box protrudes from the surface and again appears out of place. The poor appearance of a conventional wiring box and cover is especially relevant in residential brick construction where the box and cover are often very evident. For example, mounting exterior lights for entry doorway illumination places the box in a very visual position.

Various devices are shown in the prior art which are designed to improve the appearance of an electrical wiring box mounted to exterior walls. U.S. Pat. Nos. 4,920,708 and 5,000,409 disclose decorative trim plates for around exterior electrical fixtures. These devices merely provide a surrounding plate for lighting fixtures mounted to a wall rather than providing the structure needed for installation within a brick and morter wall. Similarly, U.S. Pat. No. 5,166,476 discloses an electrical junction boxioutlet which provides an outer panel larger than the electrical junction box which it surrounds. However, this concept is not intended for installation within brick construction but rather mounting on the surface of the wall. These surface mounted devices require additional sealing means to prevent moisture seeping into the building structure.

U.S. Pat. No. 5,918,431 discloses a recess mount apparatus allowing for “a continuous opening for permitting passage of a conduit, cable or other elongated member therethrough. Similarly, U.S. Pat. No. 5,326,060 discloses a two part wall mount assembly for simplified installation of an electrical wiring box. These devices are designed to mount to the sheeting of the stud wall prior to installation of siding and are not intended for nor provide for installation in brick construction. They provide no structure and are not the size or shape of a standard brick. Furthermore, they do not attempt to cover the enclosed fixture but rather provide only a surrounding decorative trim for a standard box and cover.

Thus, there is the need for an electrical wiring box which is simpler to install within a brick wall. In addition, there exists a need for an electrical wiring box which would eliminate the need for additional mortar being used during installation. There is also a need for an electrical wiring box which provides effective sealing of moisture from entering the building structure.

There is also a need for a cover assembly which mates with an electrical wiring box which simulates a brick face for improved appearance while opening for user access to the enclosed electrical fixture. There is also a need for a cover which simulates a brick face for improved appearance while being fixedly mated to an electrical wiring box thus providing a means to simplify installation of an external fixture to the box.

### SUMMARY OF THE INVENTION

The present invention is embodied in a box with a generally parallelopiped shape with one open side and integral internal structure. The outer dimensions of the box is sized and shaped to match a standard fired clay building brick as defined by the Brick Industry Association. The internal structure of the box is sized and shaped to match a standard electrical wiring box as defined by the National Electric Code. The box is designed to replace a standard electrical wiring box within a wall and enclose electrical wiring terminations, receptacles, switches, etc. In addition, the invention is designed to provide mounting means for other conventional electrical fixtures.

The present invention also incorporates a generally rectangular cover which closes the open side of the box. Three embodiments of the cover are disclosed with each embodiments sized to match a standard building brick face. In the first embodiment, the cover is configured to mount to the aforementioned electrical wiring box and is hinged to open thus allowing ready access to the enclosed electrical fixture. The second embodiment of the cover does not open but is fixedly attached to the aforementioned electrical wiring box thus providing a solid mounting surface for mounting of an exterior electrical fixture. The third embodiment of the cover is designed to mate with and cover a conventional sized electrical wiring box with length equal to a fraction of a complete brick.

It is an object of this invention to provide an electrical wiring box which is easily installed within a brick wall. A second object of this invention is to provide an electrical wiring box which, when installed in a brick wall takes the place of a standard brick and does not require cutting of a brick, or bricks, to make it fit. A third object of this invention is to provide an electrical wiring box which, when installed in a brick wall, does not require additional mortar to position. Another object of this invention is to provide an electrical wiring box which seals out moisture when set in the wall and surrounded by mortar.

A further object of this invention is to provide a cover for an electrical wiring box which simulates a brick face thus blending into the surrounding wall. An additional object of this invention is to provide a cover for an electrical wiring box which simulates a brick face but opens to allow easy access to the enclosed outlet. Finally, it is an object of this invention to provide an alternative cover for an electrical wiring box which simulates a brick face but is fixedly mated to the box thus allowing secure installation of an exterior fixture at the location of the box.

It is to be understood that both this general summary and the following detailed description are not limiting but are intended to provide further explanation of the invention claimed. The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF DRAWINGS

FIG. 1 is a perspective view of an electrical wiring box as disclosed in the present invention.

FIG. 2 is a perspective view of an electrical wiring box of FIG. 1 as partially installed in a brick wall.

FIG. 3 is an exploded perspective view of an electrical wiring box of FIG. 2 following installation within a brick wall along with a hinged cover assembly.

FIG. 4 is a cross sectional view of an electrical wiring box of FIG. 3 as installed in a brick wall.

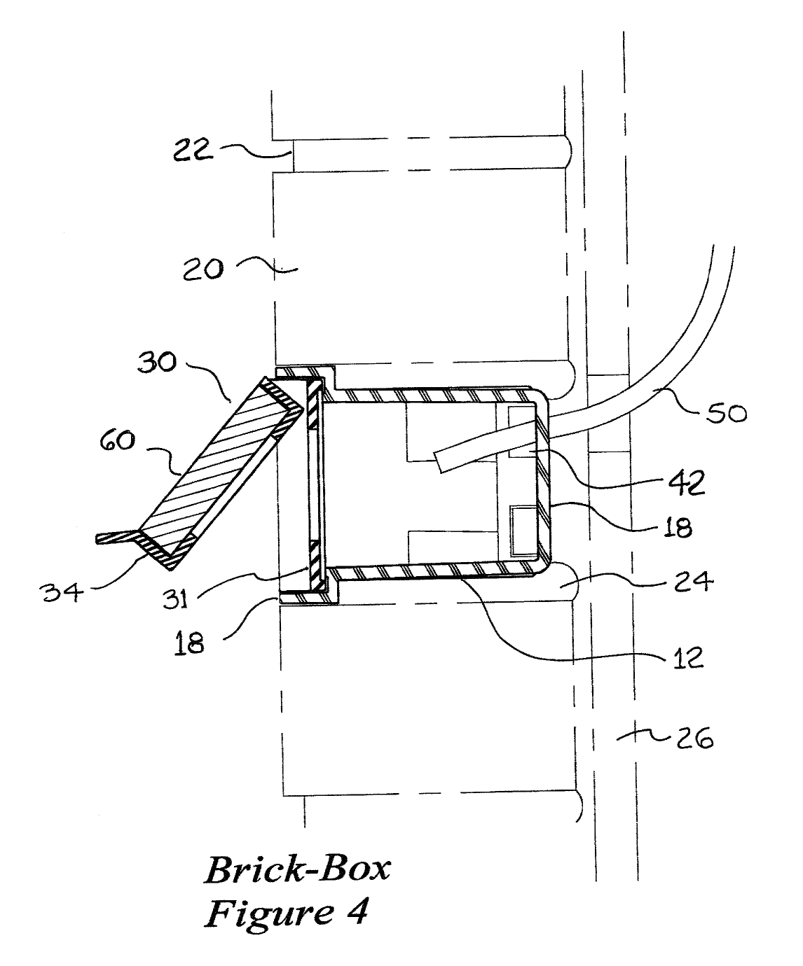

FIG. 5 is an exploded perspective view of an electrical wiring box of FIG. 2 following installation within a brick wall with a second embodiment of a cover assembly.

FIG. 6 is a cross sectional view of an electrical wiring box of FIG. 5 as installed in a brick wall.

FIG. 7. is a perspective view of a second embodiment of an electrical wiring box with reduced length as disclosed in the present invention.

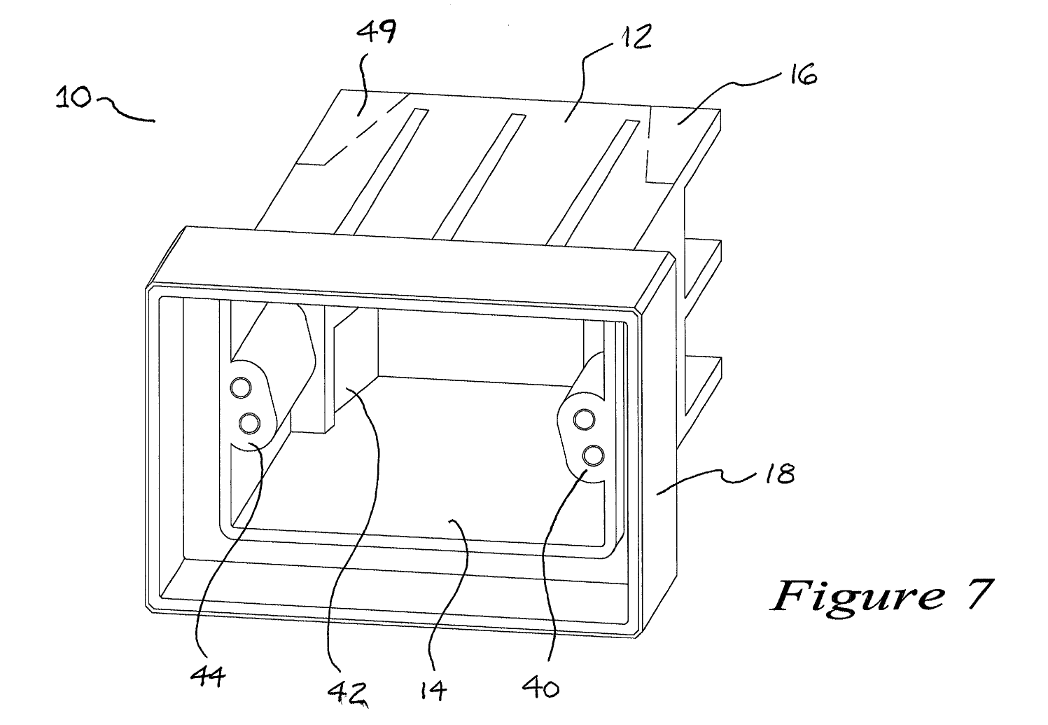

FIG. 8. is a perspective view of a third embodiment of a cover to mate with a conventional electrical wiring box as disclosed in the present invention.

### DESCRIPTION OF THE PREFERRED EMBODIMENT.

While the present invention is capable of embodiment in various forms, there is shown in the drawings and will hereinafter be described a presently preferred embodiment with the understanding that the present disclosure is to be considered as an exemplification of the invention, and is not intended to limit the invention to the specific embodiment illustrated.

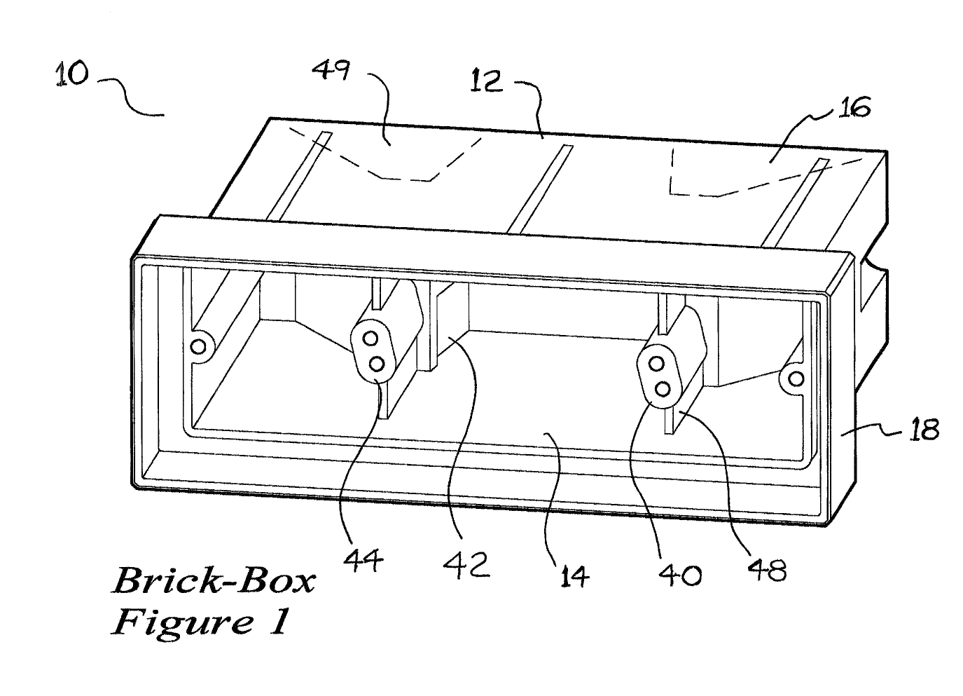

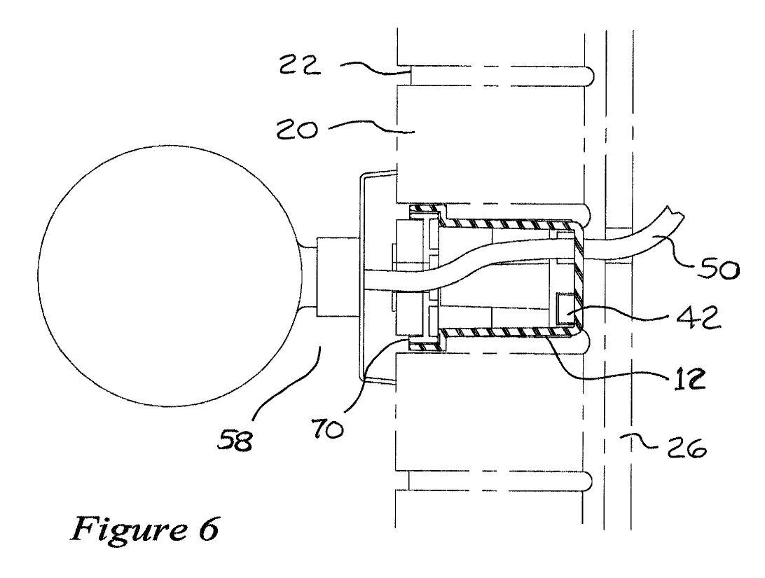

Referring now to the drawings, and more particularly to FIG. 1 and 6 which show a perspective view of an electrical wiring box generally indicated at 10 having the shape of a box 12 shaped generally as a parallelopiped with one open side 14.

The outer surfaces of the box 16 depicted are shaped and sized to match a standard building brick 20. The box 12 has an extended outer lip 18 with width matching a standard surrounding mortar joint 22. The extended outer lip 18 is used as a reference plane to position the box and to keep the mortar 24 from interfering with the installation and operation of the cover 30 as described later.

The electrical wiring box 10 incorporates provisions 40 for standard electrical components to be installed. Wire entry holes 42 are provided for electrical wires 50 to be installed through the rear side 19 of the box 12 (opposite the open side 14). These Wire entry holes 42 can be open holes, perforated holes that can be punched out, or other wire clamping devices as depicted in the prior art. A first set of screw bosses 44 are provided for mounting standard electrical fiftings 62 such as outlet and switches with conventional screws 56. A second set of screw bosses 46 are provided for mounting an external electrical fixture 58 such as a coach light.

Internal ribbing 48 is provided to allow the box 10 to hold the weight of any bricks and mortar placed on top of the box 10 prior to the mortar 24 setting.

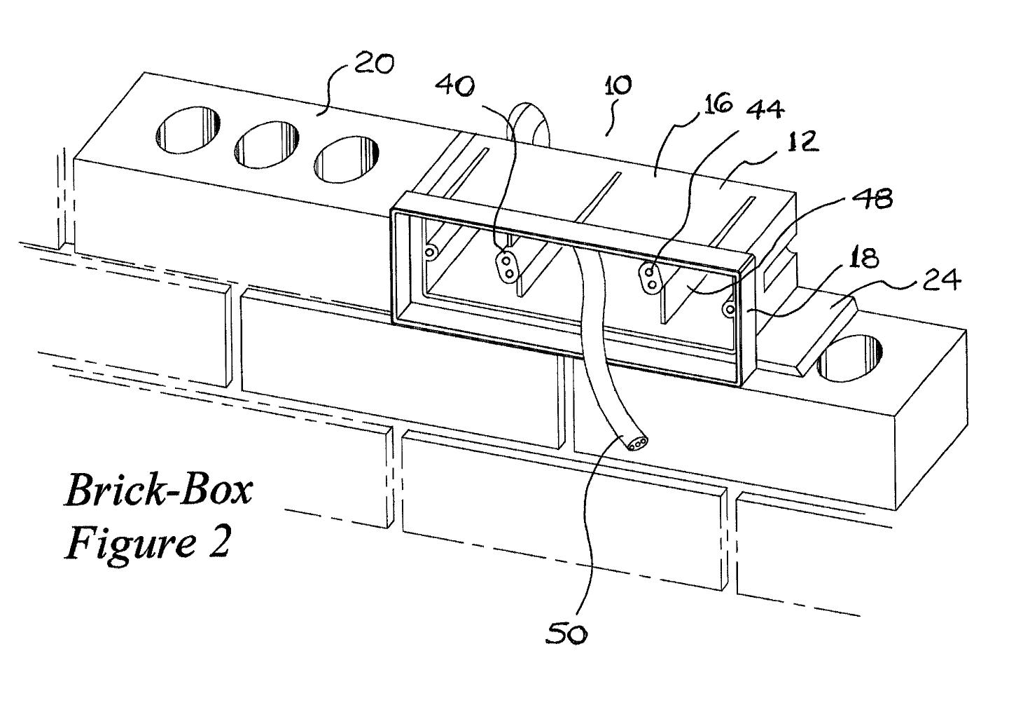

During a typical installation, the electrical wires 50 are brought though a hole in the stud wall sheeting 26. The wires 50 are placed through the wire entry holes 42 in the box 12 and the box is left hanging or temporarily attached to the stud wall. When the brick veneer is laid up over the stud wall, the box 12 is placed on the proceeding course of bricks in the desired location, as seen in FIG. 2. Rear wire cavities 49 are provided at both ends of the box 10 to allow some lateral positioning of the box 12 during installation.

Mortar is placed around the box 10 and behind the extended outer lip 18 to hold the box in position and provide a moisture seal. The extended outer lip 18 serves to provide a convenient reference surface for placing the box 12 relative to the bricks and mortar already in place. Attaching the box 12 to the stud wall sheeting 26 with screws or nails, prior to, or after installation, is optional.

After the electrical box 10 is installed, the remaining bricks and mortar may then be laid on top of the box 10 to complete the brick veneer wall. The weight of the bricks and mortar courses is supported by the internal ribbing 48 within the electrical box 10.

Thus the present invention allows for simplified installation of an electrical wiring box at a desired location in a brick and mortar wall. It also provides an electrical wiring box that does not require additional mortar or cutting of bricks to be installed. It further provides for the effective sealing of moisture away from the internal structure of the building.

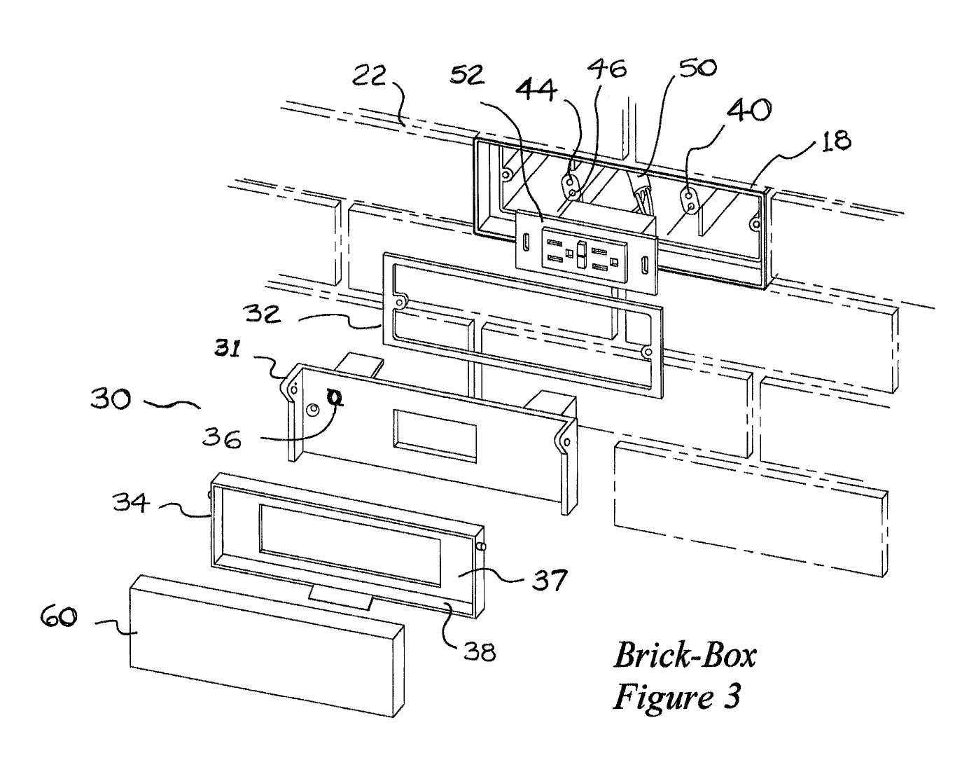

As shown in FIG. 3, an electrical fitting 52 can be installed in the electrical box 10 in a conventional manner using screws driven into screw bosses 44. A cover assembly 30 is then installed over the open side 14 of the electrical box 12 using screws driven into the electrical fitting in compliance with the applicable electrical code. The cover assembly 30 incorporates a cover plate 31 and a sealing gasket 32 which together act to seal the box 10 from moisture.

The cover assembly 30 also incorporates a hinged lid 34 to allow access to the enclosed electrical fitting 52. The cover assembly 30 fits entirely within the aforementioned extended outer lip 18 of the electrical wiring box 10. Thus the extended outer lip 18 assures that the mortar 24 does not interfere with the operation of the hinged lid 34.

Some provision is needed to keep the hinged lid 34 closed so that moisture cannot enter the electrical fitting 52 when not in use. This is accomplished using either a spring 36 or the weight of the hinged lid 34. A sealing bead 37 is added to the inside surface of the hinged lid 34 to seal moisture out of the electrical fitting 52. Other methods disclosed in the prior art may be used as well, such as an “O” ring.

A recessed cavity 38 in the exterior surface of the hinged lid 34 can be provided to accept a thin rectangular simulated brick 60.

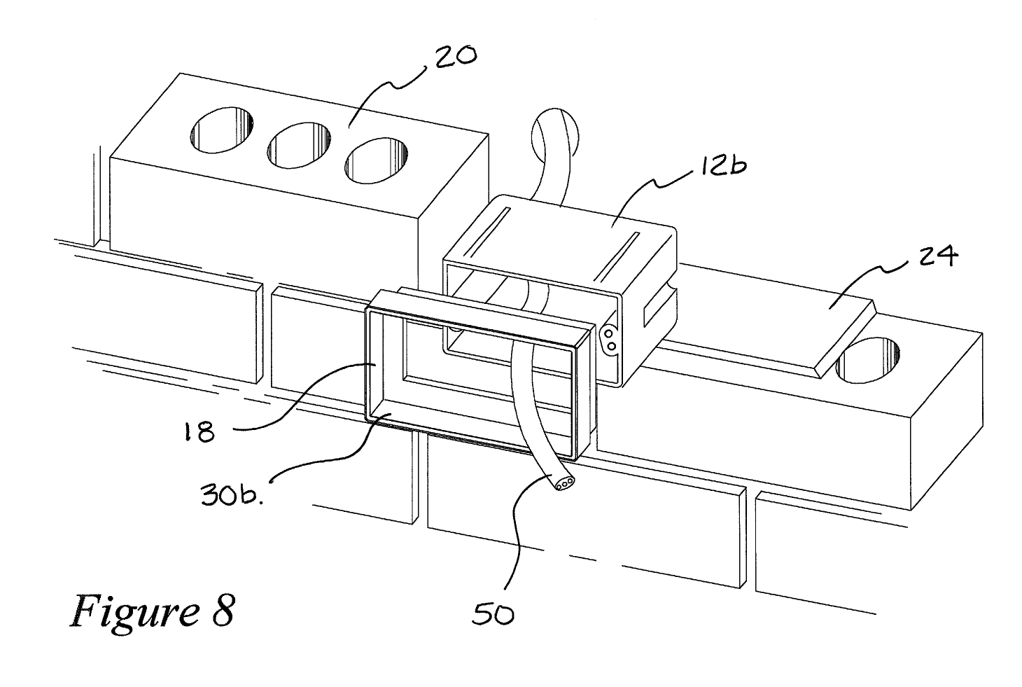

As seen in FIG. 8, the second embodiment of this invention has the cover assembly 30b sized to mate with an electrical wiring box 12b of standard dimensions and construction. The cover assembly 30b thus allows a standard electrical box 12b to blend in with the surrounding brick veneer construction. Any means of attachment can be used to mate the cover assembly 30b to the standard electrical box 12b before or after installation in the wall.

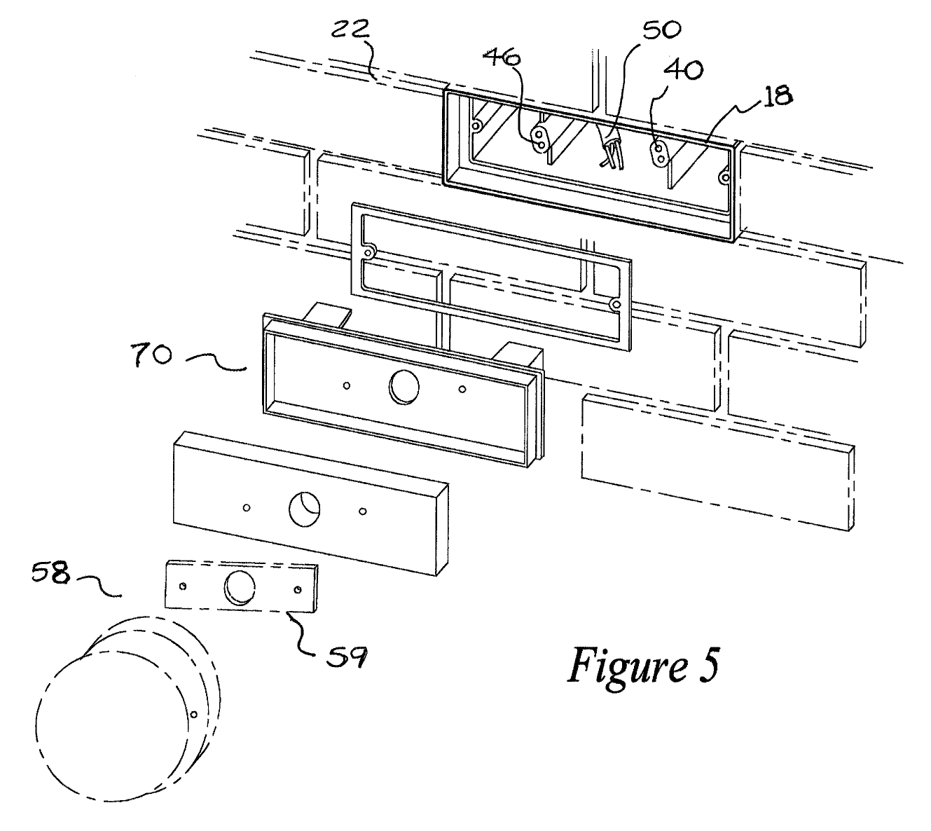

When the electrical box is being used to mount an external electrical fixture 58, as seen in FIG. 5, a mounting cover 70 is attached to the electrical wiring box 10 using screws driven into the second set of screw bosses 46. The external electrical fixture 58 is then mounted to the box using conventional hardware 59. A simulated brick with mounting holes 22 may be fitted in a recess 72 in the mounting cover 70. The mounting cover 70 can be sized to mate with an electrical box of any size.

The electrical wiring box 10, and cover 30 or 70 may be manufactured of any non-corrosive metal or plastic resin depending upon sensitivity to cost and the requirements of the application. The simulated bricks 60 or 62 may be constructed of plastic resin and painted to match the surrounding brick or made of fired clay and provided by the manufacturer of the brick being used. Furthermore, the recessed cavity 38 or 72 may be sized to accept a standard clay brick sample used extensively in the industry during sales presentations.

Thus the present invention allows for a decorative cover which simulates a brick face so that it blends into the surrounding wall. The present invention allows for the decorative cover to either open to allow access to the enclosed electrical fitting or be fixedly mounted to allow for installation of a exterior fixture.

This disclosure describes the invention in use with brick construction. The invention, and all embodiments thereof, is just as applicable to stone, block and other masonry applications.

It will be apparent to those skilled in the art that various modifications and variations can be made in the method and system of the present invention without departing from the spirit or scope of the invention. Thus, the present invention is not limited by the foregoing descriptions but is intended to cover all modifications and variations that come within the scope of the spirit of the invention and the claims that follow.

What is claimed is:

1. An electrical wiring box for installation in a masonry wall comprising:
a rectilinear box of standard size and specification with:
internal structure, and:
having an extended outer lip.

2. The electrical wiring box of claim 1 wherein said extended outer lip provides a reference plane for positioning the box in said masonry wall.

3. The electrical wiring box of claim 1 wherein said extended outer lip keeps mortar from interfering with a cover attached to said box.

4. The electrical wiring box of claim 3 wherein said cover is movable.

5. The electrical wiring box of claim 3 wherein said cover is removable.

6. The electrical wiring box of claim 1 wherein said extended outer lip provides a sealing function to the masonry wall.

7. A cover assembly for the electrical wiring box of claim 1 comprising:
a cover plate sized to cover an open side of said electrical wiring box;
a means for sealing moisture out of said electrical wiring box;
a hinged cover;
a means for attaching said cover assembly to the electrical wiring box.

8. A cover assembly of claim 7 sized to fit within the extended outer lip of the electrical wiring box.

9. A cover assembly of claim 7 with a cavity to hold a simulated brick.

10. A cover assembly for the electrical wiring box of claim 1 comprising:
a cover plate sized to cover an open side of said electrical wiring box;
a means for sealing moisture out of said electrical wiring box;
a means for attaching said cover assembly to the electrical wiring box.
a means for attaching an external electrical fixture to the electrical wiring box.

11. A cover assembly of claim 10 sized to fit within said extended outer lip.

12. A cover assembly of claim 10 with the appearance of a standard fired clay building brick.

13. A method of providing an improved electrical wiring box situated in a masonry wall comprising the steps of:
a) placing an extended lip adjacent an open side of an electrical wiring box;
b) using the combination of the electrical wiring box with the extended lip to replace an element of the masonry wall, wherein;
c) said extended lip provides a means for aligning said box with said wall.

14. The method of claim 13 wherein said extended lip provides an improved sealing means between said box and said wall.

15. The method of claim 13 wherein said extended lip keeps mortar outside the open side of said box so as not to interfere with an attached cover.

16. The method of claim 15 wherein said extended lip incorporates a recess for holding and positioning a cover, wherein: said cover is positioned flush with said masonry wall.

17. A method of claim 16 wherein said cover is movable wherein access mad be had to the inside of said box.

18. A method of claim 16 wherein said cover is fixed but removable wherein an electrical fixture may be attached to said cover.
